(19) United States
(12) Patent Application Publication
(10) Pub. No.: US 2005/0255885 A1
(43) Pub. Date: Nov. 17, 2005

(54) Of a subscriber identity module by several mobile communication devices

(76) Inventors: Frank Majewski, Berlin (DE); Rolf Morich, Berlin (DE)

Correspondence Address: BELL, BOYD & LLOYD, LLC, P. O. BOX 1135, CHICAGO, IL, 60690-1135, US

(21) Appl. No.: 10/516,774

(22) PCT Filed: May 21, 2003
(86) PCT No.: PCT/DE03/01688

§ 371 Date: Jun. 27, 2005

(30) Foreign Application Priority Data
Jun. 5, 2002 (DE) 102 25 457.5

(51) Int. Cl. H04B 1/38

(52) U.S. Cl. 455/558

(57) ABSTRACT

A method is provided for achieving an external access of a first mobile communication terminal (ME) to a Subscriber Identity Module (SIM) of a second mobile communication terminal (ME). A logical interface between the first and the second mobile communication terminal is defined by which a logical autonomous communication between the first and second mobile communication terminal is established. Also provided is an arrangement of at least one first and one second mobile communication terminal (ME), in which a logical interface is defined by which the first mobile communication terminal has access to a SIM of the second mobile communication terminal.

### BACKGROUND OF THE INVENTION

The present invention relates to a method for implementing access by a first mobile communication appliance (mobile equipment ME) to a subscriber identity module (SIM) or universal subscriber identity module (USIM) in a second mobile communication appliance (ME). In this case, the mobile communication appliance may be, by way of example, a mobile phone, a car telephone, a modem, a radio modem or a wireless module.

A SIM card in a mobile communication appliance is used to store data for authentication in GSM, GPRS or UMTS mobile radio networks and other user-related information. In addition, the SIM is used to allocate the network resources used by a mobile communication appliance to a user and hence to an account.

A SIM card includes a processor which, inter alia, looks after an algorithm for secure authentication in the network. This processor is located on a card, a “smart card,” which is inserted into a SIM card reader. This reader is, in turn, integrated in a mobile communication network.

As such, any mobile communication appliance which wants to register and authenticate itself in a GSM/UMTS mobile radio network needs to have a SIM. Since the account to be identified is associated with one user, however, the use of a number of mobile communication appliances by one user is possible only by virtue of different logical users (i.e., different mobile communication appliances), being allocated to one account on the books; for example, using a “twin card” from D1.

To date, it has not been possible for one user with different mobile communication appliances to register in a GSM mobile radio network using one identity; i.e., using one SIM.

With the expansion of the possible mobile services which can be used with a mobile communication appliance, the demands on the mobile communication appliances are increasing considerably. It follows from this that a user uses various mobile services using a number of mobile communication appliances which are specifically for the respective service.

To allow the user to access the GSM/UMTS mobile radio network using various mobile communication appliances, it is necessary for the user to be able to register with the GSM/UMTS mobile radio network using each mobile communication appliance.

The present invention is directed toward a method and a system including mobile communication appliances which a user can use to register in a GSM/UMTS mobile radio network as quickly and easily as possible using a number of mobile communication appliances.

### SUMMARY OF THE INVENTION

Accordingly, the present invention provides a method for implementing external access by a first mobile communication appliance (ME) to a subscriber identity module (SIM) in a second mobile communication appliance (ME), where a logical interface between the first and second mobile communication appliances is defined which permits logical autonomous communication between the first and second mobile communication appliances.

To date, every mobile communication appliance has had to incorporate a SIM for identifying a user or subscriber. The SIM is part of a mobile communication appliance. To allocate a number of SIM cards (i.e., in principle, a number of mobile communication appliances), to a user or his/her account, some mobile radio providers have “twin cards.” These cards are used, by way of example, to settle accounts for two mobile communication appliances belonging to a user together.

This solution has drawbacks, however. Since two mobile communication appliances with separate SIM cards are addressed by just one telephone number, the corresponding network does not know which appliance is to be used for signaling incoming calls. Additional coordination complexity by the network or user is required in order to identify the active communication appliance; e.g., use of the last mobile communication appliance registered in the network.

There is no opportunity for automatic changeover between the mobile communication appliances.

In addition, a user is not able to use one mobile communication appliance to access the SIM in another mobile communication appliance. As such, services such as a telephone book are available to him/her only on the mobile communication appliance which is connected directly to the SIM card reader, for example.

Another drawback is that each mobile communication appliance needs to contain a separate SIM with a card reader. This is very expensive.

The present invention now provides a method which allows a mobile communication appliance to access the subscriber identity module (SIM) in another mobile communication appliance. In this case, the access takes place via an external logical interface. If a mobile communication appliance does not have a SIM available, the present invention allows an inventively defined logical interface to be used to access the data on the SIM card in another mobile communication appliance.

In one embodiment of the inventive method, the first and second mobile communication appliances contain a respective adaptation layer which adapts logical communication between the first and second mobile communication appliances to the logical interface. As such, a SIM service manager is provided which controls the access to the external SIM.

In addition, the logical interface defined is preferably an AT-command-based interface. The logical communication is independent of the underlying transmission technology.

In a further embodiment of the inventive method, the logical interface uses a client/server architecture. The adaptation layer provided in accordance with the present invention is part of the aforementioned SIM service manager. The adaptation layer adapts the logical communication between a client and a server to the logical, preferably AT-command-based interface. In this case, the mobile communication appliance without a SIM takes on the role of the client, whereas the mobile communication appliance with the SIM provides the “SIM Service” service and thus adopts the role of the server. The server, or more precisely the SIM access server, allows another mobile communication appliance to access the data on a SIM card using an external logical interface. The server may be, by way of example, a mobile telephone which has an integrated SIM card. A radio or cable link can be used by the mobile telephone to allow, as a server, other mobile communication appliances to access his/her SIM card.

The client, or more precisely the SIM access client, uses a server's SIM card via an appliance connection to such server using an external logical interface. The SIM access client may be, by way of example, a GSM/GPRS module which is mounted in a car. This module is intended to align, by way of example, the communication via a mobile radio network with the specific environment.

The client sends a request, for example, to the server. This is preferably done by sending the request to the server as an AT command via an external AT-command-based interface. The server responds with a Response information item, which is sent to the client; likewise, preferably as an AT command. The server can report events even without prior requesting by the client using “unsolicited result codes” (URCs).

One great advantage of the present invention is the use of an AT command interface to implement external access to a SIM; i.e., to permit SIM sharing. In this case, a mobile communication appliance (which then acts as a server) provides another mobile communication appliance (which is then a client and wishes to use a service) with a SIM which makes it possible to use the service.

In a further embodiment of the inventive method, the logical interface uses RS-232, USB, Bluetooth, Wireless-LAN (WLAN) or Ultra-Wide-Band (UWB) as transmission technology.

The logical interface's independence of the transmission technology results in the advantage, by way of example, that the SIM sharing easily can be transferred to different instances of application.

The present invention also relates to a corresponding system including at least one first and a second mobile communication appliance (ME), where a logical interface is defined which provides the first mobile communication appliance with access to a SIM in the second mobile communication appliance.

In this case, as already mentioned, the logical interface is preferably an AT-command-based interface.

In one embodiment of the inventive system, the first and second mobile communication appliances contain a respective adaptation layer which adapts logical communication between the first and second mobile communication appliances to the logical interface.

Preferably, the logical interface can use RS-232, USB, Bluetooth, Wireless-LAN (WLAN) or Ultra-Wide-Band (UWB) as transmission technology.

Additional features and advantages of the present invention are described in, and will be apparent from, the following Detailed Description of the Invention and the Figures.

### BRIEF DESCRIPTION OF THE FIGURES

FIG. 1 shows a schematic illustration of an embodiment of the flow of the method of the present invention.

### DETAILED DESCRIPTION OF THE INVENTION

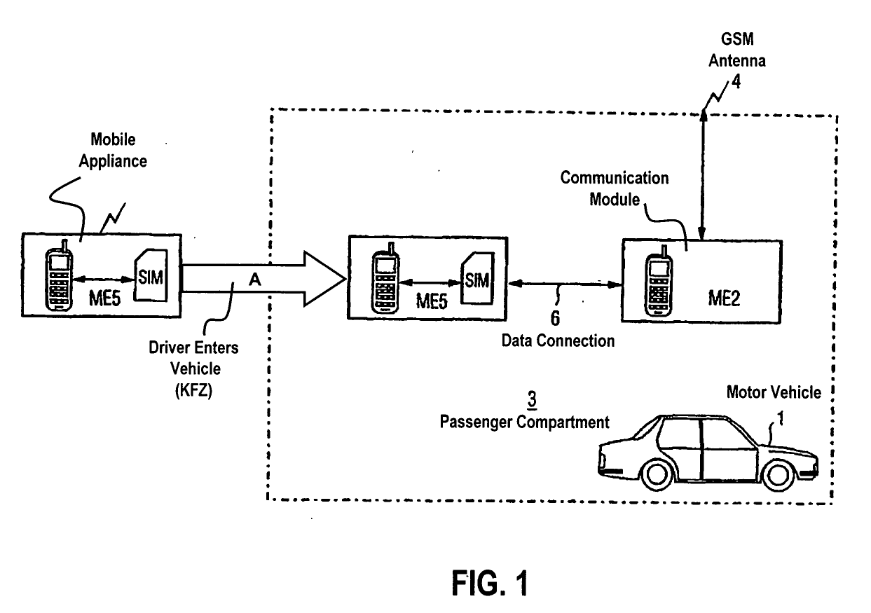

FIG. 1 shows one possible application of the inventive method in a motor vehicle 1. The motor vehicle (KFZ) 1 contains a permanently installed mobile communication appliance ME 2 in the form of a GSM/GPRS communication module which is optimized to the demands, inter alia relating to vibration and temperature resistance, on the environment. The tasks of the ME 2 are, inter alia, accident emergency call, transmission of navigation data, access to vehicle data for service purposes and telemetry, for example.

The permanently installed ME 2 uses its antenna 4 arranged outside of the passenger compartment 3 to provide wireless access to the mobile radio network. The ME 2 does not have its own SIM card, however, and is therefore configured as a client. If a user with a mobile telephone ME 5 now gets into the passenger compartment 3, he can put the ME 5 into a device 6 provided for such purpose. This device provides a data link, such as a serial data cable, to the fitted GSM/GPRS module ME 2. The ME 5 is configured as a server and makes its SIM available to the fitted ME 2. The ME 2 thus undertakes the communication with the mobile radio network after the ME 5 has turned off its GSM/GPRS air interface. Accordingly, the user is provided with a communication system which is optimized to this environment.

Although the present invention has been described with reference to specific embodiments, those of skill in the art will recognize that changes may be made thereto without departing from the spirit and scope of the present invention as set forth in the hereafter appended claims.

1-8. (canceled)

9. A method for implementing external access by a first mobile communication appliance to a subscriber identity module in a second mobile communication appliance, the method comprising:
defining a logical AT-command-based interface between the first and second mobile communication appliances; and
permitting, via the logical AT-command-based interface, logical autonomous communication between the first and second mobile communication appliances.

10. A method for implementing external access by a first mobile communication appliance to a subscriber identity module in a second mobile communication appliance as claimed in claim 9, wherein the first and second mobile communication appliances contain a respective adaptation layer which adapts logical communication between the first and second mobile communication appliances to the logical AT-command-based interface.

11. A method for implementing external access by a first mobile communication appliance to a subscriber identity module in a second mobile communication appliance as claimed in claim 9, wherein the logical AT-command-based interface uses a client/server architecture.

12. A method for implementing external access by a first mobile communication appliance to a subscriber identity module in a second mobile communication appliance as claimed in claim 9, wherein the logical AT-command-based interface is used independently of a transmission technology being used, the logical AT-command-based interface using one of RS-232, USB, Bluetooth, Wireless-LAN and Ultra-Wide-Band.

13. A system for implementing external access by a first mobile communication appliance to a subscriber identity module in a second mobile communication appliance, comprising:
a first mobile communication appliance;
a second mobile communication appliance; and
a logical AT-command-based interface defined between the first and second mobile communication appliances, wherein the logical AT-command-based interface provides the first mobile communication appliance with access to a subscriber identity module in the second mobile communication appliance.

14. A system for implementing external access by a first mobile communication appliance to a subscriber identity module in a second mobile communication appliance as claimed in claim 13, wherein the first and second mobile communication appliances contain a respective adaptation layer which adapts logical communication between the first and second mobile communication appliances to the logical AT-command-based interface.

15. A system for implementing external access by a first mobile communication appliance to a subscriber identity module in a second mobile communication appliance as claimed in claim 13, wherein the logical AT-command-based interface may use one of RS-232, USB, Bluetooth, Wireless-LAN and Ultra-Wide-Band as transmission technology.

16. A system for implementing external access by a first mobile communication appliance to a subscriber identity module in a second mobile communication appliance as claimed in claim 13, wherein no subscriber identity module is used in the first mobile communication appliance.
